(19) United States
(12) Patent Application Publication
(10) Pub. No.: US 2007/0169108 A1
(43) Pub. Date: Jul. 19, 2007

(54) Method of executing software applications

(75) Inventors: Fabien Marcel Jacques Guillorit, Eindhoven (NL); Jeroen Francis Johan Van Dooren, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/563,933

(22) PCT Filed: Jul. 2, 2004
(86) PCT No.: PCT/IB04/51101

§ 371 Date: Jan. 9, 2006

(51) Int. Cl. G06F 9/445

(52) U.S. Cl. 717/174

(57) ABSTRACT

There is provided a method of executing one or more Xlet software applications in a broadcasting system (10) including a broadcast provider (20) coupled via at least one communication link (30) to at least one corresponding user interface (40, 50) including associated computing hardware therein. The method comprising the steps of: (a) receiving one or more requests from at least one user (60) associated with said at least one user interface (40, 50) for executing at least one preferred software application; (b) checking memory associated with said at least one user interface (40, 50) to determine whether or not said at least one preferred software application is resident therein; (c) when said at least one software application is found to be already stored in said memory and validated, loading from the memory said at least one preferred software application to said computing hardware associated with said at least one user interface (40, 50) and then executing the software application in said computing hardware; and (d) when said at least one application is found to be not already stored in the memory, receiving from the broadcast provider (20) said at least one preferred software application, loading said at least one application to the computing hardware, validating said at least one application in the computing hardware and then subsequently executing said at least one application when validated in the computing hardware.

The present invention relates to methods of executing software applications in communication apparatus; in particular, but not exclusively, the present invention relates to methods of executing software applications implemented in conjunction with Java™ software, such applications being known as Xlets; such Xlet execution is susceptible to occur in apparatus such as Multimedia Home Platforms (MEP), for example set-top-boxes (STB) suitable for use with interactive digital television (DTV) equipment in domestic environments. Moreover, the invention also relates to apparatus capable of implementing the method when executing software applications, for example Xlet software applications.

A paper with title “DVB-MHP/JavaTV™ Data Transport Mechanism” was presented at the 40^{th} International Conference on Technology and Object-Orientated Languages and Systems (TOOLS Pacific 2002), Sydney, Australia by J. Jones. In the paper, Java DVB-MPH standards are described which are capable of providing a wide range of technical opportunities. Adoption of such standards is especially pertinent in the field of digital television, for example with regard to interactive television. An industry-led consortium of over 300 broadcasters, manufacturers, network operators, software developers, regulatory bodies amongst others in 35 countries presently endeavour to design global standards for the delivery of digital television and data services. Such endeavours are contemporarily known as the “Digital Video Broadcasting Project”, often referred to in abbreviated form as the “DVB” project.

The DVB project specifies Java™ technology as a suitable software application environment language. Java™ is a high-level, object-orientated programming language. In use, Java software source matter is translated into platform-independent byte-codes for interpretation by a Virtual Machine. Software applications downloaded to set-top-boxes (STB) are typically Java™ software applications built from a suite of application programming interfaces (API's) tailored specifically for use in an interactive television environment.

A part of the standard, namely MHP 1.0.1 defines a first profile wherein the digital broadcast of audio and video services is combined with executable software applications. The software applications enable one or more television viewers to interact locally and do not, for example, require an interaction channel to be provided. Moreover, the standard also defines a second profile wherein, in addition to features provided to one or more users by enhanced broadcasting, there are also provided thereto a range of interactive services associated or independent from the broadcasting services, such interactive services requiring the provision of an additional interaction channel.

In the situation of Multimedia Home Platform (MHP), there are utilized MHP software applications which are conventionally regarded as not being complete Java™ applications in a normal sense. These MHP software applications are more like Applets in that they are loaded onto a given platform and executed therein under supervision of a life cycle manager, for example the platform being a set-top-box (STB) and the life cycle manager being implemented by dedicated software therein. The MHP software applications are conveniently referred to as “Xlets”.

Thus, the inventors have appreciated that MHP broadcast involves the transmission of Java™ applications such as Xlets. These Xlets are susceptible to being downloaded onto MHP-compliant products by a Digital Media Command and Control (DSM-CC).

Moreover, the inventors have appreciated that Xlet applications are often continuously broadcast but seldom modified, for example where a “carousel” repetition pattern for broadcast software applications is utilized. By way of example, a person at home owns a set-top-box (STB) linked to a television. The user is capable, using the television in combination with the STB, of selecting a label or symbol on the television screen corresponding to one ore more desired services and then invoking the symbol, conventionally known as “zapping” the symbol. Such “zapping” of the symbol results in a corresponding Xlet being detected. Now, if the user wants to use the Xlet, associated classes and images of the Xlet are downloaded to the STB via a communication medium such as satellite connection and/or fibre-optical link. Subsequent to downloading, a Security Manager implemented in software in the STB is operable to check the downloaded Xlet, namely classes and associated images, prior to the Xlet being loaded onto a Virtual Machine provided in the STB and then executed therein. In a situation where the Security Manager identifies unsafe classes and associated images, for example corrupted by one or more software viruses, the Security Manager is operable to prevent the Virtual Machine from executing the Xlet.

The inventors have appreciated that the Security Manager requires considerable time to perform its security checking task as described in the foregoing. Such delay is a significant problem for which the inventors have devised a method capable of at least partially addressing the problem.

The aforementioned problem appears not to be appreciated in the art. For example, in a United States published patent application no. US 2002/0120945A1, there is described a software system for use with a Digital Television (DTV) set-top-box. The system employs a software bus application programming interface (API) specially designed to render the set-top-box compatible with two standard DASE architectures, namely first and second architectures. In the first architecture, a procedural application engine includes a declarative application engine. In the second architecture, there is includes a procedural application engine containing an associated procedural. The applications engines each have associated therewith an application engine manager utilizing a function cell router to intercept all DASE infrastructure API's incoming from software applications downloaded by the set-top-box from a DTV broadcast. All API's are routed through the application manager, and all application engines are required to implement a software bus API included therein. There is also included a specially-designed software interface operable to enable convenient installation of additional applications by simply changing one line in software code.

A first object of the present invention is to provide a method of executing software applications, for example in set-top-boxes in association with digital television (DTV), which is more rapid in operation when security checking software applications.

A second object of the present invention is to provide apparatus operable according to the aforementioned method.

According to a first aspect of the present invention, there is provided a method of executing one or more software applications in a broadcasting system including a broadcast provider coupled via at least one communication link to at least one corresponding user interface including associated computing means therein, the method comprising the steps of:

(a) receiving one or more requests from at least one user associated with said at least one user interface for executing at least one preferred software application;

(b) checking memory associated with said at least one user interface to determine whether or not said at least one preferred software application is resident therein;

(c) when said at least one software application is found to be already stored in said memory and validated, loading from the memory said at least one preferred software application to said computing means associated with said at least one user interface and then executing the software application in said computing means; and

(d) when said at least one application is found to be not already stored in the memory, receiving from the broadcast provider said at least one preferred software application, loading said at least one application to the computing means, validating said at least one application in the computing means and then subsequently executing said at least one application when validated in the computing means.

The method is of advantage in that it is capable of addressing at least one of the objects of the invention.

Preferably, in step (d) of the method, said at least one software application when validated is stored in the memory for subsequent potential re-use. Such re-use is capable of rendering the user interface more responsive and rapid in use.

Preferably, for example in order to circumvent a need to include excessive amounts of memory in each user interface, each user interface is provided with memory managing means operable to overwrite less frequently user-requested software applications with more recently user-requested software applications, thereby allowing for re-utilization of memory capacity for at least one more frequently user-requested software application.

Preferably, in order to render each user interface responsive to updates in software applications, in step (b) of the method, at least one validated software application stored in the memory is compared with at least one corresponding software application broadcast from the broadcast provider to check for similarity, such that:

(a) said at least one validated application stored in the memory is executed in the computing means when correspondence between said at least one stored validated application and at least one broadcast application is identified; and

(b) said at least one broadcast application is checked for validity, and stored in the memory when successfully validated and subsequently executed in the computing means,

the method thereby operable to update said at least one application stored in the memory when newer corresponding at least one application is broadcast from the broadcast provider.

Preferably, where bi-direction communication is supported in the at least one communication link, said at least one user interface and corresponding at least one communication link are operable to convey one or more user requests for the preferred software application to the broadcast provider which is responsive to broadcast said requested preferred application to said at least one user interface.

Preferably, for example alternatively or additionally, the broadcast provider is operable to broadcast via said at least one communication link one or more software applications in a repetitive temporal manner for selective loading into associated memory at said at least one user interface. Such a “carousel” manner of software application broadcasting is capable of supporting user-interactive digital television (DTV) simultaneously with the at least one communication link being mono-directional. More preferably, for example to provide an acceptably short user-request response delay, the broadcast provider is operable to broadcast said one or more software applications in a pseudo-continuous manner.

Preferably, in the method, the broadcasting system is a digital television (DTV) broadcasting system wherein said at least one user-interface corresponds to at least one step-top-box (STB) coupled to associated displaying means, and said at least one communication link is implemented by at least one of wireless links, fibre optical links and conductive wire communication links. More preferably, to cater for different cost/size compromises in manufacture, said displaying means comprises at least one of a cathode ray tube, a pixel plasma display, a pixel back-lit liquid crystal display and a pixel projection liquid crystal display.

Preferably, in order to support convenient user interaction, said at least one preferred software application is selected by use of at least one graphic representative symbol presented to said at least one user at said at least one user interface. More preferably, said at least one graphic symbol is implemented as at least one graphics icon.

Preferably, additionally or alternatively to digital television (DTV), said at least one user interface is implemented as at least one mobile telephone provided with corresponding graphic display.

In order to provide rapid start-up when energized to one or more user requests, the memory is implemented as persistent memory operable to retain data therein when de-energized. More preferably, the memory is implemented as non-volatile memory utilizing at least one of: solid-state flash memory, magnetic disc memory.

Preferably, for example for wide-spread general acceptability, said at least one software application is implemented as one or more Java Xlets. Java is an internationally-known, widely-used contemporary computer language.

Preferably, in step (d) of the method, validation is performed by a software-implemented Security Manager and validated software applications are executed on a software-implemented Virtual Machine provided in said computing means.

Preferably, to provide more predictable uniform and stable operation whilst utilizing the computing means efficiently, downloading, validation and storage in said memory of validated said at least one software application is performed as a continuous concurrent background activity in said computing means.

According to a second aspect of the present invention, there is provided a broadcasting system for executing one or more software applications, the system including a broadcast provider coupled via at least one communication link to at least one corresponding user interface, each user interface comprising:

(a) interfacing means for receiving one or more requests from at least one user associated with said user interface for executing at least one preferred software application therein;

(b) memory for storing at least one software application therein;

(c) computing means for determining whether or not said at least one preferred software application is already validated and stored in said memory, for validating one or more software applications received from the broadcast provider where said one or more software applications are not already stored in the memory, and for executing one or more validated software applications in response to said one or more user requests such that said one or more validated software applications stored in said memory are executed in preference to validating corresponding one or more software applications receivable from the broadcast provider so as to provide said at least one user with more rapid temporal response to said one or more requests from said at least one user.

Preferably, in the system, said computing means is operable to store said at least one software application when validated in the memory for subsequent potential re-use.

Preferably, each user interface is provided with memory managing means operable to overwrite less frequently requested software applications with more recently requested software applications, thereby allowing for re-utilization of memory capacity for at least one more frequently user-requested software application.

Preferably, in the system, the computing means is operable to compare at least one validated software application stored in the memory with at least one corresponding software application broadcast from the broadcast provider to check for similarity, such that:

(a) said at least one validated application stored in the memory is executed in the computing means when correspondence between said at least one stored application and at least one broadcast application is identified; and

(b) said at least one broadcast application is checked for validity, and stored in the memory if validated and subsequently executed in the computing means,

the computing means thereby being operable to update said at least one application stored in the memory when newer corresponding at least one application is broadcast from the broadcast provider.

Preferably, in the system, said at least one user interface and corresponding at least one communication link are operable to convey one or more user requests for the preferred software application to the broadcast provider which is responsive to broadcast said requested preferred application to said at least one user interface.

Preferably, in the system, the broadcast provider is operable to broadcast via said at least one communication link one or more software applications in a repetitive temporal manner for selective loading at said at least one user interface. More preferably, the broadcast provider is operable to broadcast said one or more software applications in a pseudo-continuous manner.

Preferably, the broadcasting system is a digital television broadcasting system wherein said at least one user-interface corresponds to at least one step-top-box coupled to associated displaying means, and said at least one communication link is implemented by at least one of wireless links, fibre optical links and conductive wire communication links. More preferably, said displaying means comprises at least one of a cathode ray tube, a pixel plasma display, a pixel back-lit liquid crystal display and a pixel projection liquid crystal display.

Preferably, said at least one preferred software application is selectable by use of at least one graphic representative symbol presented to said at least one user at said at least one user interface. More preferably, said at least one graphic symbol is implemented as at least one graphics icon.

Preferably, alternatively or additionally to digital television (DTV), said at least one user interface is implemented as at least one mobile telephone provided with corresponding graphic display.

Preferably, the memory is implemented as persistent memory operable to retain data therein when de-energized. More preferably, the memory is implemented as non-volatile memory utilizing at least one of: solid-state flash memory, magnetic disc memory.

Preferably, said at least one software application is implemented as one or more Java Xlets.

Preferably, the computing means is operable to perform validation by way of a software-implemented Security Manager and execute validated software applications by way of a software-implemented Virtual Machine provided in said computing means.

Preferably, said computing means is operable to download, to validate and to store in said memory said at least one validated software application as a continuous concurrent background activity.

It will be appreciated that features of the invention are susceptible to being combined in any combination without departing from the scope of the invention.

Embodiments of the invention will now be described, by way of example only, with reference to the following diagrams wherein:

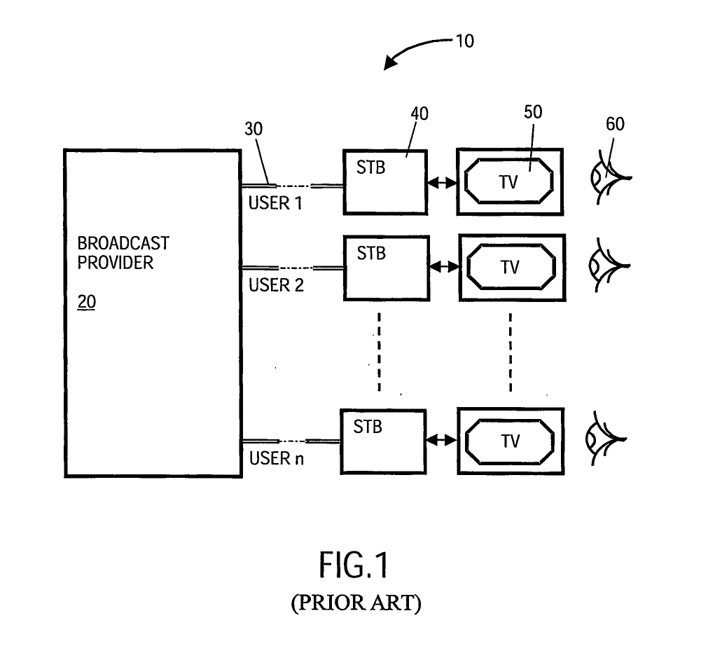

FIG. 1 is a schematic diagram of a digital television broadcasting network linked to several set-top-boxes;

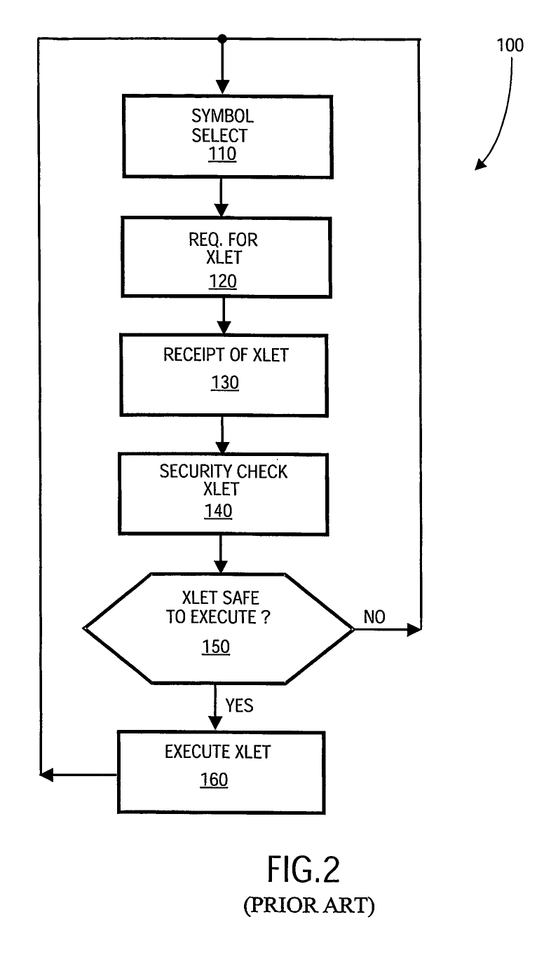

FIG. 2 is a schematic diagram of a conventional method of downloading and executing Xlet software applications in set-top-boxes (STB); and

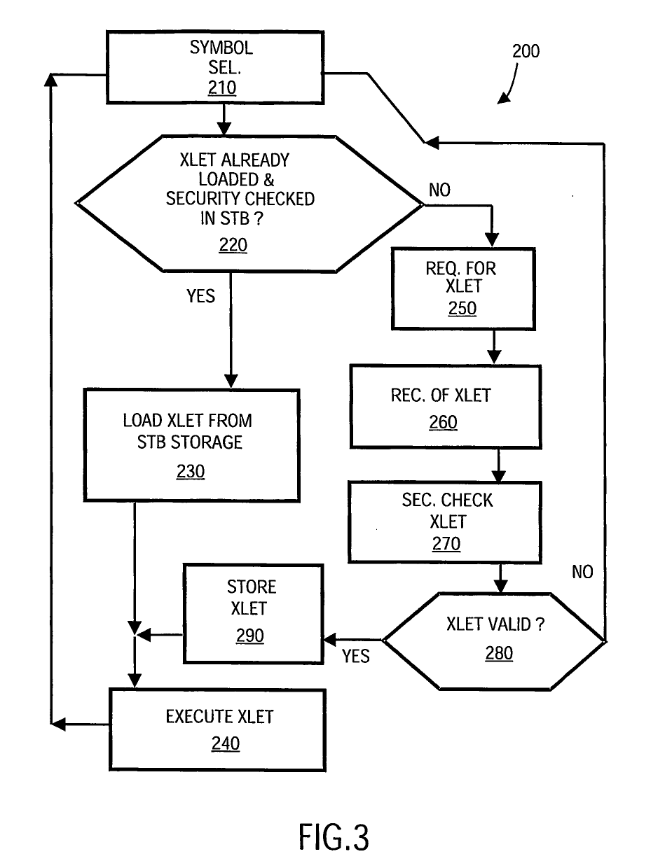

FIG. 3 is a schematic diagram of an embodiment of the method of the invention for downloading and executing Xlet software applications in set-top-boxes (STB).

In order to elucidate the present invention in context, a brief description of digital television (DTV) will firstly be described with reference to FIGS. 1 and 2.

Referring firstly to FIG. 1, there is shown a conventional DTV broadcasting network indicated generally by 10. The network 10 includes a DTV broadcast provider 20 comprising infrastructure for distribution of DTV signals. The infrastructure includes, for example, one or more of microwave wireless links, fibre optical communication links, signal switching units and in-line components such as one or more of amplifiers, regenerators, equalizers and filters. The broadcast provider 20 comprises “n” outputs for providing users 1 to “n” with DTV services. Each output is coupled via a communication link 30 which is preferably one or more of a co-axial high-frequency wire link, a wide-bandwidth fibre-optical link and a wireless radio link. Moreover, each user has associated therewith a set-top-box (STB) 40 coupled between its corresponding link 30 and a television monitor 50 viewable by the user 60. The monitor 50 is preferable one or more of a cathode ray tube (CRT) display, a pixel liquid crystal display (LCD), an LCD projection unit and a plasma display. Moreover, the monitor 50 also includes a corresponding audio system and user interface control panel, for example a miniature computer keyboard and/or a computer mouse, tracker ball or similar.

The STB 40 includes computer hardware together with high-speed signal processing hardware. The computer hardware includes at least one processor coupled via suitable digital buses to volatile and non-volatile memory devices; non-volatile memory devices are capable of providing persistent memory as will be elucidated later. The STB 40 includes software executable therein to enable it to function as a Virtual Machine, namely a substantially universal computer emulation capable of receiving, amongst other software applications, Xlets and executing them to provide the user 60 with a corresponding visual and/or audio service.

Referring next to FIG. 2, there is shown as a flow chart of processing steps executed within each STB 40; the processing steps are indicated generally by 100. The steps 100 comprise a symbol selection step 110 (SYMBOL SELECT), a request for Xlet step 120 (REQ. FOR XLET), a receipt of Xlet step 130 (RECEIPT OF XLET), an Xlet security/validation checking step 140 (SECURITY CHECK XLET), a decision step 150 (XLET SAFE TO EXECUTE?) and finally an Xlet execution step 160 (EXECUTE XLET). The steps 110 to 160 are executing in a temporal sequence as presented in FIG. 2.

Operation of the broadcasting network 10 will now be described in overview with reference to FIGS. 1 and 2.

The broadcast provider 20 is operable to output digital signals via one or more of the links 30 to their respective users 60. The digital signals comprise at least one of digital programme material, executable software and software-related data.

Each user 60 is capable of directing its corresponding STB 40 to select a given digital data stream transmitted from the provider 20, for example for selecting a preferred programme channel. Moreover, each user 60 is also capable of selecting one or more software applications to be sent to the user's STB 40 for execution therein as will now be described.

Each STB 40 is operable to receive an application request from its user 60, namely the user 60 selects a preferred option on the monitor 50; for example, the option is selected in step 110 by the user 60 moving a mouse icon displayed on the monitor 50 to a preferred icon software application symbol presented thereon.

In a first interactive mode of operation, the user 60 then forwards this request via the STB 40 to the provider 20 in step 120; for example, the user 60 presses an “execute” button or switch which causes the STB 40 to send a request via the link 30 to the broadcast provider 20. Subsequently, the provider 20 responds in step 130 by downloading one or more corresponding software applications, for example one or more Xlets, for eventual execution in the STB 40 for display on the monitor 50.

In a second interactive mode of operation, where the broadcast provider 20 outputs software applications repetitively and continuously in a “carousel” manner, the STB 40 responds to the request from the user 60 by isolating the selected Xlet from incoming signals conveyed to the STB 40, the isolated selected Xlet being subject to eventual execution in the STB 40 for display on the monitor 50.

In steps 140, 150, in order to avoid corruption of the STB 40 and data stored therein, the STB 40 also executes validation software known as a Security Manager for validating the one or more received software applications from the broadcast provider 20, for example the aforementioned Xlets. Such validation is desirable to ensure that the software applications have been provided from a bona fide source and/or determining whether or not the software applications include computer viruses or similar aberrations likely to adversely affect operation of the STB 40.

Where an Xlet is received at one or more STB's 40, it is firstly validated by the aforesaid Security Manager software executing on the one or more STB's 40. In step 150, if the Xlet is found not to be bona-fide, it is not executed. Conversely, in step 150, if the Xlet is successfully validated by the Security Manager, it is loaded onto the Virtual Machine provided by the SBT 40 and then executed in step 160 to provide the user 60 with a corresponding service, for example a weather report, a report of investment bank performance, a stock market report and/or a video game.

The inventors have appreciated that the Security Manager in the STB's 40 is relatively slow in step 140 to execute its validation function with a result that the user 60 must wait a period before a software application icon or similar identified on the monitor 50 appears to respond and function. Moreover, when software applications are relatively large and bandwidth available through the link 30 is restricted, significant time is required to load the applications in step 130 from the broadcast provider 20 via the link 30 to its associated STB 40. Such delay is susceptible to being disconcerting and potentially irritating to the user 60.

When software applications have been executed within the STB's 40, they are conventionally erased and/or overwritten by new subsequent software applications provided from the network provider 20.

As described in the foregoing, where the network 10 is provided with unidirectional links 30, the network provider 10 repetitively transmits software applications which are normally ignored at each of the STB's 40 unless users 60 thereat have caused their STB's 40 in steps 120, 130 to identify and load corresponding selected software applications, for example Xlets, into memory of the STB's 40 for validation in steps 140, 150 for subsequent execution if bona fide.

The inventors have appreciated that software applications provided from the broadcast provider 20 are repetitively broadcast in the aforesaid second interactive mode, namely effectively continuously broadcast in the manner of a data “carousel”, but rarely modified. Where the user 60 “zaps” a software application icon as described in the foregoing, a corresponding Xlet is identified. If the user wants to execute the Xlet, classes and pictures associated with the Xlet are downloaded from the provider 20 to the user's 60 STB 40. Next, the classes are loaded by the Virtual Machine in a loading phase during which the Security Manager verifies each class before the Xlet is finally executed, such verification requiring relatively significant execution time durations in the STB's 40.

The inventors have appreciated for the present invention that it is desirable to regard the downloading of Xlets to one or more of the STB's 40 as a two-stage process, namely a storage process and an execution process. It is especially desirable that such storage is non-volatile persistent storage, for example in solid-state flash memory and/or magnetic hard-disc memory which retains data therein on power-down, namely when power is disconnected from the STB's 40. Other types of non-volatile persistent memory are also susceptible for use to provide such persistent storage.

Thus, in the method of the present invention, a first occasion an Xlet is executed on one or more of the STB's 40, the STB's 40 are programmed to invoke their Security Manager to validate the Xlet in all associated classes and then store the validated Xlet in persistent memory of the STB's 40. At subsequent instances where the user 60 invokes a preferred Xlet icon on the user's 40 monitor 50, the corresponding STB 40 firstly checks to determine whether or not the preferred Xlet is already stored in persistent storage of the STB 40. The STB 40 then checks to ensure that the validated stored Xlet is similar to that continuously output from the broadcast provider 20, for example as output therefrom in its “carousel” mode of operation for broadcasting Xlets. If the broadcast and stored Xlet are identical, the STB 40 will identify therefrom that the two Xlets are both valid and then proceed to execute the stored Xlet. Where the preferred stored Xlet differs from that output from the broadcast provider 20, for example by way of a software update and/or upgrading implemented by the provider 20, the SBT 40 is operable to download the preferred selected Xlet from the provider 20 and then subject it to validation checking by the Security Manager before loading it into the persistent storage and then executing it as described earlier in the Virtual Machine.

As an alternative to storing complete validated Xlets, the STB's 40 are susceptible to storing validation data, for example a check sum, corresponding to the validated preferred Xlet, so that an incoming received Xlet can be quickly validated by using the checksum prior to execution thereof in the Virtual Machine; such an implementation of the method of the invention is less demanding in memory capacity within the STB's 40.

The method of the invention will further be elucidated with reference to FIG. 3.

In FIG. 3, there is shown a flow chart of processing steps corresponding to an embodiment of the invention; the processing steps are indicated generally by 200. The steps 200 include a symbol selection step 210 (SYMBOL SEL.), a software application check step 220 (XLET ALREADY LOADED & SECURITY CHECKED IN STB?), an Xlet loading from persistent memory loading step 230 (LOAD XLET FROM STB STORAGE), an Xlet execution step 240 (EXECUTE XLET), a request for Xlet step 250 (REQ. FOR XLET), an Xlet receive step 260 (REC. OF XLET), an Xlet security validation step 270 (SEC. CHECK XLET), an Xlet validation checking step 280 (XLET VALID?), and finally an Xlet storage in persistent memory step 290 (STORE XLET). The steps 200 are executed in a temporal sequence as illustrated with branching at the step 220 depending on whether or not a user selected Xlet is already available in persistent storage of the STB 40 ready for subsequent execution in step 240 or is to be requested in step 250, received in step 260, validated by the aforementioned Security Manager in step 270, checked for validity in step 280 and finally stored and subsequently executed in steps 240, 290 if valid.

Security validation in steps 270, 280 is performed in the aforementioned Security Manager software executed by the STB 40. Moreover, execution of validated Xlets is performed by the Virtual Machine provided in computing hardware of the STB 40.

Preferably, each STB 40 is operable to store all detected Xlets in persistent memory associated therewith. Such storage of Xlets is preferably a continuously executing background activity within each of the STB's 40. In order to prevent the STB's 40 exhausting capacity of their persistent memory, each SBT 40 is arranged to maintain an internal Xlet record, for example in the form of a journal in memory; each STB 40 is operable to utilize its Xlet record to determine least used Xlets and non-executed Xlets and delete them from persistent storage so as to free memory space therein, thereby avoiding memory exhaustion. Thus, for example, a new Xlet selected by the user 60 that is not yet stored in persistent memory of the associated STB 40 will then preferably replace a least-used Xlet already stored in persistent memory of the STB 40.

Each STB 40 preferably employs Digital Storage Media Command and Control (DSN-CC) for downloading modules, each module including one or more of classes and files. Module versions are beneficially identified in Download Info Indication (DII) known in the context of DTV. Preferably, such DII information is advantageously stored together with corresponding Xlets in persistent memory of the STB's 40. Thus, when the user 60 request an Xlet to be executed, the DSM-CC will check to determine whether or not the Xlet is already stored and whether or not it is valid; if the Xlet is not found to be valid, the Xlet is downloaded from the provider 20, validated and then executed as described in the foregoing.

Thus, each STB 40 includes class, loader software which is operable to invoke the aforementioned Security Manager if stored Xlets have not been executed before or have been in the-meantime updated.

It will be appreciated that embodiments of the invention described in the foregoing are susceptible to being modified without departing from the scope of the invention.

For example, although the method of the invention described in the foregoing is susceptible to being used in DTV systems including STB's, the method is also applicable to mobile telephone networks in which the STB's 40 and their monitors 50 are substituted by hand-held mobile telephones, for example mobile telephones including liquid crystal display suitable for displaying 2-dimensional graphical images.

It will also be appreciated that the STB's 40 and their associated monitors 50 are susceptible to being spatially co-located in corresponding housing and are not limited to being two mutually detachable items.

In the foregoing, expressions such as “include”, “contain”, “comprise”, “incorporate”, “have”, “has” are to be construed as being non-exclusive, namely such expressions do not exclude other components or items also being present. Moreover, reference to the singular shall also be construed to include the plural.

1. A method of executing one or more software applications in a broadcasting system (10) including a broadcast provider (20) coupled via at least one communication link (30) to at least one corresponding user interface (40, 50) including associated computing means therein, the method comprising the steps of:
(a) receiving one or more requests from at least one user (60) associated with said at least one user interface (40, 50) for executing at least one preferred software application;
(b) checking memory associated with said at least one user interface (40, 50) to determine whether or not said at least one preferred software application is resident therein;
(c) when said at least one software application is found to be already stored in said memory and validated, loading from the memory said at least one preferred software application to said computing means associated with said at least one user interface (40, 50) and then executing the software application in said computing means; and
(d) when said at least one application is found to be not already stored in the memory, receiving from the broadcast provider (20) said at least one preferred software application, loading said at least one application to the computing means, validating said at least one application in the computing means and then subsequently executing said at least one application when validated in the computing means.

2. A method according to claim 1, wherein in step (d), said at least one software application when validated is stored in the memory for subsequent potential re-use.

3. A method according to claim 2, wherein each user interface (40, 50) is provided with memory managing means operable to overwrite less frequently user-requested software applications with more recently user-requested software applications, thereby allowing for re-utilization of memory capacity for at least one more frequently user-requested software application.

4. A method according to claim 1, wherein, in step (b), at least one validated software application stored in the memory is compared with at least one corresponding software application broadcast from the broadcast provider to check for similarity, such that:
(a) said at least one validated application stored in the memory is executed in the computing means when correspondence between said at least one stored validated application and at least one broadcast application is identified; and
(b) said at least one broadcast application is checked for validity, and stored in the memory when successfully validated and subsequently executed in the computing means,
the method thereby operable to update said at least one application stored in the memory when newer corresponding at least one application is broadcast from the broadcast provider (20).

5. A method according to claim 1, wherein said at least one user interface (40, 50) and corresponding at least one communication link (30) are operable to convey one or more user requests for the preferred software application to the broadcast provider (20) which is responsive to broadcast said requested preferred application to said at least one user interface (40, 50).

6. A method according to claim 1, wherein the broadcast provider is operable to broadcast via said at least one communication link one or more software applications in a repetitive temporal manner for selective loading into associated memory at said at least one user interface.

7. A method according to claim 6, wherein the broadcast provider is operable to broadcast said one or more software applications in a pseudo-continuous manner.

8. A method according to claim 1, wherein said broadcasting system is a digital television broadcasting system wherein said at least one user-interface corresponds to at least one step-top-box (40) coupled to associated displaying means (50), and said at least one communication link (30) is implemented by at least one of wireless links, fibre optical links and conductive wire communication links.

9. A method according to claim 8, wherein said displaying means (50) comprises at least one of a cathode ray tube, a pixel plasma display, a pixel back-lit liquid crystal display and a pixel projection liquid crystal display.

10. A method according to claim 1, wherein said at least one preferred software application is selected by use of at least one graphic representative symbol presented to said at least one user at said at least one user interface.

11. A method according to claim 10, wherein said at least one graphic symbol is implemented as at least one graphics icon.

12. A method according to claim 1, wherein said at least one user interface is implemented as at least one mobile telephone provided with corresponding graphic display.

13. A method according to claim 1, wherein the memory is implemented as persistent memory operable to retain data therein when de-energized.

14. A method according to claim 13, wherein the memory is implemented as non-volatile memory utilizing at least one of: solid-state flash memory, magnetic disc memory.

15. A method according to claim 1, wherein said at least one software application is implemented as one or more Java Xlets.

16. A method according to claim 1, wherein, in step (d), validation is performed by a software-implemented Security Manager and validated software applications are executed on a software-implemented Virtual Machine provided in said computing means.

17. A method according to claim 1, wherein downloading, validation and storage in said memory of validated said at least one software application is performed as a continuous concurrent background activity in said computing means.

18. A broadcasting system (10) for executing one or more software applications, the system (10) including a broadcast provider (20) coupled via at least one communication link (30) to at least one corresponding user interface (40, 50), each user interface (40, 50) comprising:
(a) interfacing means for receiving one or more requests from at least one user (60) associated with said user interface (40, 50) for executing at least one preferred software application therein;
(b) memory for storing at least one software application therein;
(c) computing means for determining whether or not said at least one preferred software application is already validated and stored in said memory, for validating one or more software applications received from the broadcast provider where said one or more software applications are not already stored in the memory, and for executing one or more validated software applications in response to said one or more user requests such that said one or more validated software applications stored in said memory are executed in preference to validating corresponding one or more software applications receivable from the broadcast provider so as to provide said at least one user with more rapid temporal response to said one or more requests from said at least one user.

19. A system according to claim 18, wherein said computing means is operable to store said at least one software application when validated in the memory for subsequent potential re-use.

20. A system according to claim 19, wherein each user interface is provided with memory managing means operable to overwrite less frequently requested software applications with more recently requested software applications, thereby allowing for re-utilization of memory capacity for at least one more frequently user-requested software application.

21. A system according to claim 18, wherein the computing means is operable to compare at least one validated software application stored in the memory with at least one corresponding software application broadcast from the broadcast provider to check for similarity, such that:
(a) said at least one validated application stored in the memory is executed in the computing means when correspondence between said at least one stored application and at least one broadcast application is identified; and
(b) said at least one broadcast application is checked for validity, and stored in the memory if validated and subsequently executed in the computing means,
the computing means thereby being operable to update said at least one application stored in the memory when newer corresponding at least one application is broadcast from the broadcast provider.

22. A system according to claim 18, wherein said at least one user interface and corresponding at least one communication link are operable to convey one or more user requests for the preferred software application to the broadcast provider which is responsive to broadcast said requested preferred application to said at least one user interface.

23. A system according to claim 18, wherein the broadcast provider is operable to broadcast via said at least one communication link one or more software applications in a repetitive temporal manner for selective loading at said at least one user interface.

24. A system according to claim 23, wherein the broadcast provider is operable to broadcast said one or more software applications in a pseudo-continuous manner.

25. A system according to claim 18, wherein said broadcasting system is a digital television broadcasting system wherein said at least one user-interface corresponds to at least one step-top-box coupled to associated displaying means, and said at least one communication link is implemented by at least one of wireless links, fibre optical links and conductive wire communication links.

26. A system according to claim 25, wherein said displaying means comprises at least one of a cathode ray tube, a pixel plasma display, a pixel back-lit liquid crystal display and a pixel projection liquid crystal display.

27. A system according to claim 18, wherein said at least one preferred software application is selectable by use of at least one graphic representative symbol presented to said at least one user at said at least one user interface.

28. A system according to claim 27, wherein said at least one graphic symbol is implemented as at least one graphics icon.

29. A system according to claim 18, wherein said at least one user interface is implemented as at least one mobile telephone provided with corresponding graphic display.

30. A system according to claim 18, wherein the memory is implemented as persistent memory operable to retain data therein when de-energized.

31. A system according to claim 30, wherein the memory is implemented as non-volatile memory utilizing at least one of: solid-state flash memory, magnetic disc memory.

32. A system according to claim 18, wherein said at least one software application is implemented as one or more Java Xlets.

33. A system according to claim 18, wherein the computing means is operable to perform validation by way of a software-implemented Security Manager and execute validated software applications by way of a software-implemented Virtual Machine provided in said computing means.

34. A system according to claim 18, wherein said computing means is operable to download, to validate and to store in said memory said at least one validated software application as a continuous concurrent background activity.
